(19) United States
(12) Patent Application Publication
(10) Pub. No.: US 2020/0137533 A1
(43) Pub. Date: Apr. 30, 2020

(54) BRIDGE DEVICE FOR WIRELESS SENSORS

(71) Applicant: Carrier Corporation, Palm Beach Gardens, FL (US)

(72) Inventor: Ramakrishna Gattu, Suryapet (IN)

(21) Appl. No.: 16/660,209

(22) Filed: Oct. 22, 2019

(30) Foreign Application Priority Data
Oct. 24, 2018 (IN) 201811040103

(51) Int. Cl. H04W 4/38; H04L 29/08; H04L 29/06; H04W 8/00; H04Q 9/02

(52) U.S. Cl. CPC H04W 4/38; H04L 67/12; H04Q 9/02; H04W 8/005; H04L 69/18

(57) ABSTRACT

A sensing system includes a wireless sensor configured to generate data corresponding to an environmental condition; a thermostat configured to control an HVAC system in response to the data; a bridge device configured to receive the data from the wireless sensor and configured to transmit the data to the thermostat; wherein the bridge device is configured to communicate with the thermostat using a first communication protocol and configured to communicate with the wireless sensor using a second communication protocol.

### FOREIGN PRIORITY

This application claims priority to Indian Patent Application No. 201811040103, filed Oct. 24, 2018, and all the benefits accruing therefrom under 35 U.S.C. § 119, the contents of which in its entirety are herein incorporated by reference.

### BACKGROUND

The embodiments described herein relate generally to sensing systems including wireless sensors, and more particularly to a bridge device for wireless sensors in a sensing system.

Wireless sensors may be used to sense environmental conditions, such as temperature and humidity, and report the sensor data to a control device, such as a thermostat. There may be situations where the wireless sensors use a communication protocol different than the thermostat. For example, as new communication protocols are introduced, simple components (e.g., wireless sensors) may include the new communication protocol but more complex devices (e.g., a thermostat) may not be readily equipped with the new communication protocol. This makes it difficult to use the new communication protocol.

### SUMMARY

According to an embodiment, a sensing system includes a wireless sensor configured to generate data corresponding to an environmental condition; a thermostat configured to control an HVAC system in response to the data; a bridge device configured to receive the data from the wireless sensor and configured to transmit the data to the thermostat; wherein the bridge device is configured to communicate with the thermostat using a first communication protocol and configured to communicate with the wireless sensor using a second communication protocol.

In addition to one or more of the features described herein, or as an alternative, further embodiments of the system may include wherein the wireless sensor includes a plurality of wireless sensors.

In addition to one or more of the features described herein, or as an alternative, further embodiments of the system may include wherein the bridge device is configured to aggregate data from the wireless sensors and provide the aggregated data to the thermostat.

In addition to one or more of the features described herein, or as an alternative, further embodiments of the system may include wherein the first communication protocol is a first version of a communication standard and the second communication protocol is a second version of the communication standard.

In addition to one or more of the features described herein, or as an alternative, further embodiments of the system may include wherein the wireless sensor is configured as a broadcaster and the bridge device is configured as an observer.

In addition to one or more of the features described herein, or as an alternative, further embodiments of the system may include wherein the wireless sensor is configured as a peripheral and the bridge device is configured as a central.

In addition to one or more of the features described herein, or as an alternative, further embodiments of the system may include wherein the bridge device is configured as a broadcaster and the thermostat is configured as an observer.

In addition to one or more of the features described herein, or as an alternative, further embodiments of the system may include wherein the bridge device is configured as a peripheral and the thermostat is configured as a central.

In addition to one or more of the features described herein, or as an alternative, further embodiments of the system may include wherein the bridge device is configured as a central and the thermostat is configured as a peripheral.

According to another embodiment, a method includes providing a wireless sensor configured to generate data corresponding to an environmental condition; providing a thermostat configured to control an HVAC system in response to the data; providing a bridge device configured to receive the data from the wireless sensor and configured to transmit the data to the thermostat; wherein the bridge device is configured to communicate with the thermostat using a first communication protocol and configured to communicate with the wireless sensor using a second communication protocol.

In addition to one or more of the features described herein, or as an alternative, further embodiments of the method may include provisioning the bridge device, the provisioning comprising: obtaining a wireless sensor unique identifier; obtaining a thermostat unique identifier; storing the wireless sensor unique identifier and the thermostat unique identifier in the bridge device.

In addition to one or more of the features described herein, or as an alternative, further embodiments of the method may include wherein provisioning the bridge device further comprises setting a flag in the bridge device to indicate that the provisioning has terminated.

In addition to one or more of the features described herein, or as an alternative, further embodiments of the method may include wherein the first communication protocol is a first version of a communication standard and the second communication protocol is a second version of the communication standard.

In addition to one or more of the features described herein, or as an alternative, further embodiments of the method may include wherein the wireless sensor is configured as a broadcaster and the bridge device is configured as an observer.

In addition to one or more of the features described herein, or as an alternative, further embodiments of the method may include wherein the wireless sensor is configured as a peripheral and the bridge device is configured as a central.

In addition to one or more of the features described herein, or as an alternative, further embodiments of the method may include wherein the bridge device is configured as a broadcaster and the thermostat is configured as an observer.

In addition to one or more of the features described herein, or as an alternative, further embodiments of the method may include wherein the bridge device is configured as a peripheral and the thermostat is configured as a central.

In addition to one or more of the features described herein, or as an alternative, further embodiments of the method may include wherein the bridge device is configured as a central and the thermostat is configured as a peripheral.

Technical effects of embodiments of the present disclosure include using a bridge device to provide communications between wireless sensors utilizing a second communication protocol and a thermostat utilizing a first communication protocol.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts a sensing system in an example embodiment;

FIG. 2 depicts a wireless sensor in an example embodiment;

FIG. 3 depicts process executed by the sensing system in an example embodiment.

### DETAILED DESCRIPTION

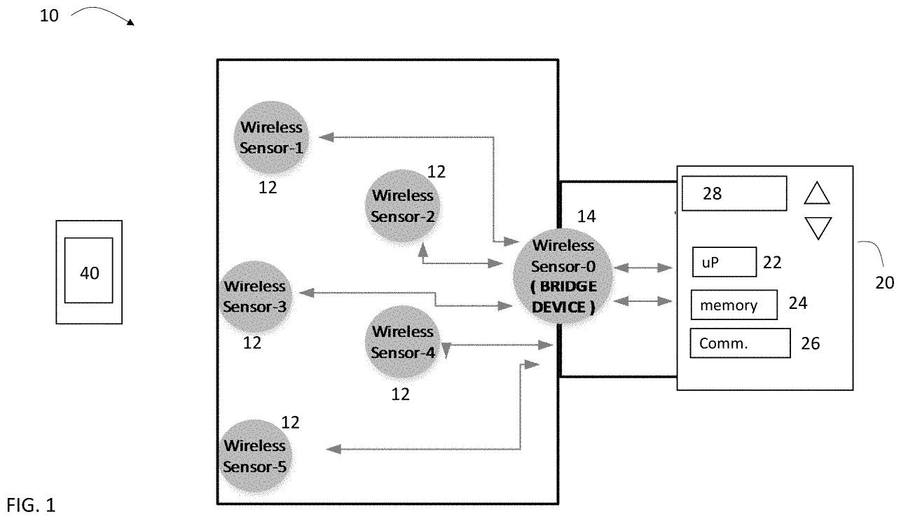

FIG. 1 depicts a sensing system 10 in an example embodiment. The sensing system 10 includes a plurality of wireless sensors 12 that detect environmental conditions, such as temperature and/or humidity. The wireless sensors 12 send data to a thermostat 20, the data corresponding to a value of the environmental condition. The wireless sensors 12 communicate with the thermostat 20 using a wireless communication protocol, such as Bluetooth Low Energy (BLE). The thermostat 20 sends controls signals to an HVAC system (not shown) to control environmental conditions in areas monitored by the wireless sensors 12.

The thermostat 20 may include a processor 22, memory 24 and communication module 26 as shown in FIG. 1. The processor 22 can be any type or combination of computer processors, such as a microprocessor, microcontroller, digital signal processor, application specific integrated circuit, programmable logic device, and/or field programmable gate array. The memory 24 is an example of a non-transitory computer readable storage medium tangibly embodied in the thermostat 20 including executable instructions stored therein, for instance, as firmware. The communication module 26 may implement a first communication protocol that is a first version of a communication standard (e.g., BLE version 4.0). A user interface 28 allows a user to control the thermostat 20.

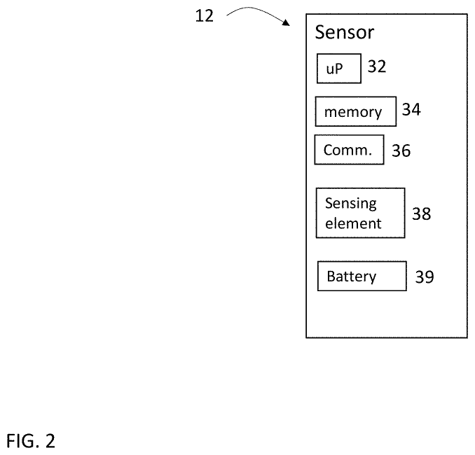

FIG. 2 depicts a wireless sensor 12 in an example embodiment. The wireless sensor 12 may include a processor 32, memory 34 and communication module 36 as shown in FIG. 2. The processor 32 can be any type or combination of computer processors, such as a microprocessor, microcontroller, digital signal processor, application specific integrated circuit, programmable logic device, and/or field programmable gate array. The memory 34 is an example of a non-transitory computer readable storage medium tangibly embodied in the wireless sensor 12 including executable instructions stored therein, for instance, as firmware. The communication module 36 may implement a second communication protocol that is a second version of the communication standard (e.g., BLE version 5.0). A sensing element 38 senses an environmental condition (e.g., temperature, humidity, etc.) in an area adjacent the wireless sensor 12. A battery 39 powers the components of the wireless sensor 12.

Referring back to FIG. 1, it is noted that the thermostat 20 and the wirelesses sensors 12 use different communication protocols. For example, the wireless sensors 12 may use BLE version 5.0 and the thermostat 20 may use BLE version 4.0. In order to accommodate the two different communication protocols, one wireless sensor is configured as a bridge device 14. The bridge device 14 is configured to receive and aggregate data from the wireless sensors 12 in BLE 5.0, realizing the benefits of BLE 5.0. This aggregated data is then passed on to the thermostat 20 in BLE 4.0. The bridge device 14 may be in close proximity of the thermostat 20 for reliable communication. The wireless sensors 12 may be distributed across multiple zones.

In the above example, the first communication protocol between the bridge device 14 and the thermostat 20 is BLE 4.0 and the second communication protocol between the bridge device 14 and the wireless sensors 12 is BLE 5.0. It is understood that various communication protocols may be used, and embodiments are not limited to BLE versions. In one example, the bridge device 14 communicates with the wireless sensors 12 using a communication protocol other than BLE, such as Zigbee or Z-Wave and the bridge device 14 communicates with the thermostat 20 using BLE. Thus, embodiments are not limited to BLE, but rather include a variety of communication protocols.

The wireless sensors 12 and the bridge device 14 may be configured in various ways. In a first configuration, the wireless sensors 12 are configured as broadcasters and the bridge device 14 is configured as an observer. In this configuration, the wireless sensors 12 broadcast data and the bridge devices 14 scans for the broadcast data. In another configuration, each wireless sensor 12 is configured as a peripheral and the bridge device 14 is configured as a central. In this configuration, the wireless sensors 12, acting as peripherals, connect to bridge device 14, acting as the central, and send the data to the bridge device 14.

As noted above, the bridge device 14 aggregates data from the wireless sensors 12 (communicated in the first communication protocol) and provides the aggregated data to the thermostat 20 in the second communication protocol. The bridge device 14 and the thermostat may be configured in various ways. In a first configuration, the bridge device 14 is configured as a broadcaster and the thermostat 20 is configured as an observer. In this configuration, the bridge device 14 aggregates the data from the wireless sensors 12 and pushes that data acting like a broadcaster. In another configuration, the bridge device 14 is configured as a peripheral and the thermostat 20 is configured as a central. In this configuration, the bridge device 14, acting as a peripheral, connects to the thermostat 20, acting as the central, and sends the data to the thermostat 20. In another configuration, the bridge device 14 is configured as a central and the thermostat 20 is configured as a peripheral. In this configuration, the thermostat 20, acting as a peripheral, connects to the bridge device 14, acting as the central, to initiate data transfer from the bridge device 14 to the thermostat 20.

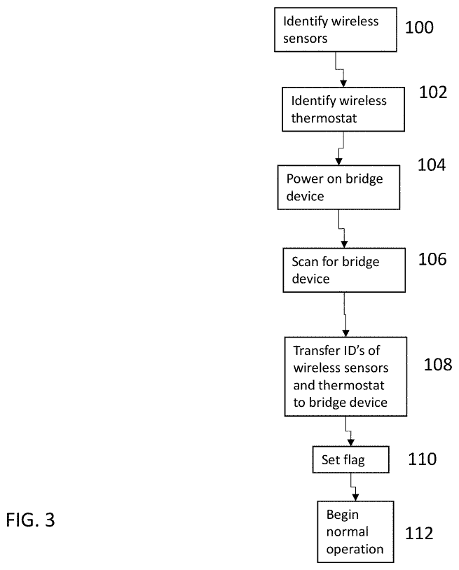

FIG. 3 depicts a process for provisioning the sensing system 10 in an example embodiment. The wireless sensors 12 and the bridge device 14 do not have any user interface to aid in provisioning. Thus, a mobile device 40 (e.g., phone, tablet, digital assistant, laptop, etc.), as shown in FIG. 1, is used to provision the sensing system 10. Each of the wireless sensors 12, the bridge device 14 and the thermoset 20 have unique identifiers (e.g., a serial number and a mac-id).

The process begins at 100 where the wireless sensors 12 are identified. This may entail manually entering the wireless sensor unique identifiers on the mobile device 40. In another embodiment, the mobile device 40 generates an interrogation signal for the wireless sensors 12 and record the wireless sensor unique identifiers that are generated by each wireless sensor 12 in response to the interrogation signal.

At 102 the thermostat 20 is identified. This may entail manually entering the thermostat unique identifier on the mobile device 40. There may be multiple thermostats, depending on the installation. In another embodiment, the mobile device 40 generates an interrogation signal for the thermostat 20 and records the thermostat unique identifier generated by each thermostat 20 in response to the interrogation signal.

At 104 the bridge device 14 is powered on. When first powered on, the bridge device 14 acts as peripheral and is open for unsecure connections. At 106, the mobile device 40 locates the bridge device 14 by sending an interrogation signal and receiving the bridge device unique identifier generated by the bridge device 14 in response to the interrogation signal.

At 108, the mobile device 40 connects to the bridge device 14 and transfers the unique identifiers of the wireless sensors 12 and the thermostat 20 to the bridge device 14. At 110, a flag in the bridge device 14 is set to indicate that the provisioning process has terminated. The bridge device 14 then identifies the wireless sensors 12 and the thermostat 20, establishes a secure connection and begins normal operation at 112, collecting data from the wireless sensors 12 and providing that data to the thermostat 20.

As described above, embodiments can be in the form of processor-implemented processes and devices for practicing those processes, such as a processor in the wireless sensors 12, the bridge device 14 and the thermostat 20. Embodiments can also be in the form of a computer program product containing instructions embodied in tangible computer readable media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A sensing system comprising:
a wireless sensor configured to generate data corresponding to an environmental condition;
a thermostat configured to control an HVAC system in response to the data;
a bridge device configured to receive the data from the wireless sensor and configured to transmit the data to the thermostat;
wherein the bridge device is configured to communicate with the thermostat using a first communication protocol and configured to communicate with the wireless sensor using a second communication protocol.

2. The sensing system of claim 1, wherein the wireless sensor includes a plurality of wireless sensors.

3. The sensing system of claim 2, wherein the bridge device is configured to aggregate data from the wireless sensors and provide the aggregated data to the thermostat.

4. The sensing system of claim 1, wherein the first communication protocol is a first version of a communication standard and the second communication protocol is a second version of the communication standard.

5. The sensing system of claim 1, wherein the wireless sensor is configured as a broadcaster and the bridge device is configured as an observer.

6. The sensing system of claim 1, wherein the wireless sensor is configured as a peripheral and the bridge device is configured as a central.

7. The sensing system of claim 1, wherein the bridge device is configured as a broadcaster and the thermostat is configured as an observer.

8. The sensing system of claim 1, wherein the bridge device is configured as a peripheral and the thermostat is configured as a central.

9. The sensing system of claim 1, wherein the bridge device is configured as a central and the thermostat is configured as a peripheral.

10. A method comprising:
providing a wireless sensor configured to generate data corresponding to an environmental condition;
providing a thermostat configured to control an HVAC system in response to the data;
providing a bridge device configured to receive the data from the wireless sensor and configured to transmit the data to the thermostat;
wherein the bridge device is configured to communicate with the thermostat using a first communication protocol and configured to communicate with the wireless sensor using a second communication protocol.

11. The method of claim 10 further comprising provisioning the bridge device, the provisioning comprising:
obtaining a wireless sensor unique identifier;
obtaining a thermostat unique identifier;
storing the wireless sensor unique identifier and the thermostat unique identifier in the bridge device.

12. The method of claim 11 wherein provisioning the bridge device further comprises setting a flag in the bridge device to indicate that the provisioning has terminated.

13. The method of claim 10, wherein the first communication protocol is a first version of a communication standard and the second communication protocol is a second version of the communication standard.

14. The method of claim 10, wherein the wireless sensor is configured as a broadcaster and the bridge device is configured as an observer.

15. The method of claim 10, wherein the wireless sensor is configured as a peripheral and the bridge device is configured as a central.

16. The method of claim 10, wherein the bridge device is configured as a broadcaster and the thermostat is configured as an observer.

17. The method of claim 10, wherein the bridge device is configured as a peripheral and the thermostat is configured as a central.

18. The method of claim 10, wherein the bridge device is configured as a central and the thermostat is configured as a peripheral.
